(19) United States
(12) Patent Application Publication
(10) Pub. No.: US 2024/0424399 A1
(43) Pub. Date: Dec. 26, 2024

(54) EQUIPMENT CONFIGURATION METHOD AND APPARATUS FOR SIMULATED CHESS PIECE CHARACTER, DEVICE, MEDIUM, AND PRODUCT

(71) Applicant: Tencent Technology (Shenzhen) Company Limited, Shenzhen (CN)

(72) Inventors: Qiang XU, Shenzhen (CN); Yuxuan LU, Shenzhen (CN)

(21) Appl. No.: 18/825,999

(22) Filed: Sep. 5, 2024

Related U.S. Application Data
(63) Continuation of application No. PCT/CN2023/127085, filed on Oct. 27, 2023.

(30) Foreign Application Priority Data
Dec. 29, 2022 (CN) 202211713558.5

(51) Int. Cl. A63F 13/56; A63F 13/77; A63F 13/79; A63F 13/822

(52) U.S. Cl. CPC A63F 13/56; A63F 13/77; A63F 13/79; A63F 13/822

(57) ABSTRACT

This application provides a method for configuring equipment for a simulated chess piece character performed by a computer device. The method includes: displaying a battle chessboard, the battle chessboard comprising at least one simulated chess piece character controlled by a robot account; in response to a lineup configuration of the simulated chess piece character in this game, displaying recommended equipment corresponding to the simulated chess piece character, the lineup configuration comprising at least one of the simulated chess piece character displayed on the battle chessboard and a simulated chess piece character that the robot account has not obtained yet; and in response to that the simulated chess piece character meets an equipping condition, assigning the recommended equipment to the robot account and displaying the simulated chess piece character equipped with the recommended equipment.

### CROSS-REFERENCE TO RELATED APPLICATIONS

This application is a continuation application of PCT Patent Application No. PCT/CN2023/127085, entitled “EQUIPMENT CONFIGURATION METHOD AND APPARATUS FOR SIMULATED CHESS PIECE CHARACTER, DEVICE, MEDIUM, AND PRODUCT” filed on Oct. 27, 2023, which claims priority to Chinese Patent Application No. 202211713558.5, entitled “EQUIPMENT CONFIGURATION METHOD AND APPARATUS FOR SIMULATED CHESS PIECE CHARACTER, DEVICE, MEDIUM, AND PRODUCT” and filed on Dec. 29, 2022, both of which are incorporated by reference in their entirety.

### FIELD OF THE TECHNOLOGY

Embodiments of this application relate to the field of computer technologies, and in particular, to an equipment configuration method and apparatus for a simulated chess piece character, a device, a medium, and a product.

### BACKGROUND OF THE DISCLOSURE

Auto chess is an emerging chess game. After players place possessed chess pieces (generally referred to as “chess piece characters”) on a chessboard, a game application program automatically controls the chess pieces to battle against each other and outputs a result of the battle. Players arrange and create chess piece character lineup to face lineup of an opponent. A life value is decreased for a loser, and ranking is determined according to an order of elimination.

During a game, the chess piece characters include main chess piece characters controlled by human players and simulated chess piece characters controlled by artificial intelligence (a robot account). A series of equipment's suitable for wearing are recommended to simulated chess piece characters according to a fixed configuration and are sorted according to priorities. The simulated chess piece characters choose to wear the recommended equipment's based on the priorities, thereby enhancing skills.

However, to recommend equipment to the most suitable simulated chess piece character, each time a new piece of equipment is obtained, it is necessary to traverse the matching between the new equipment and each simulated chess piece character to obtain the latest priority corresponding to the new equipment, resulting in an excessively high computing amount and increasing the processing power consumption of computer devices.

### SUMMARY

This application provides an equipment configuration method and apparatus for a simulated chess piece character, a device, a medium, and a product. The technical solution is as follows:

According to an aspect of this application, a method for configuring equipment for a simulated chess piece character is performed by a computer device and the method includes:
displaying a battle chessboard, the battle chessboard comprising at least one simulated chess piece character controlled by a robot account;
in response to a lineup configuration of the simulated chess piece character in this game, displaying recommended equipment corresponding to the simulated chess piece character, the lineup configuration comprising at least one of the simulated chess piece character displayed on the battle chessboard and a simulated chess piece character that the robot account has not obtained yet; and
in response to that the simulated chess piece character meets an equipping condition, assigning the recommended equipment to the robot account and displaying the simulated chess piece character equipped with the recommended equipment.

According to another aspect of this application, a computer device is provided. The computer device includes: a processor and a memory, the memory storing at least one computer program, and the at least one computer program, when loaded and executed by the processor, causing the computer device to implement the equipment configuration method for a simulated chess piece character according to the foregoing aspect.

According to another aspect of this application, a non-transitory computer-readable storage medium is provided, storing at least one computer program, and the at least one computer program, when loaded and executed by a processor of a computer device, causing the computer device to implement the equipment configuration method for a simulated chess piece character according to the foregoing aspect.

The technical solutions provided in this application have at least the following beneficial effects:

The computer device displays a battle chessboard, the battle chessboard including at least one simulated chess piece character, and the simulated chess piece character being a chess piece character controlled by a robot account; in response to a lineup configuration of the simulated chess piece character in this game, displays recommended equipment corresponding to the simulated chess piece character; and in response to that the simulated chess piece character meets an equipping condition, displays the simulated chess piece character equipped with the recommended equipment. In this application, the recommended equipment corresponding to the simulated chess piece character is obtained at once based on the lineup configuration of the simulated chess piece character in this game, and in the case that the simulated chess piece character meets the equipping condition, the simulated chess piece character is equipped with the recommended equipment. This avoids a process of calculating, each time a new piece of equipment is obtained, the matching between the new equipment and each simulated chess piece character, which reduces a computing amount and reduces the processing power consumption of the computer device.

### BRIEF DESCRIPTION OF THE DRAWINGS

FIG. 1 is a schematic diagram of an equipment configuration method for a simulated chess piece character according to an exemplary embodiment of this application;

FIG. 2 is a schematic architectural diagram of a computer system according to an exemplary embodiment of this application;

FIG. 3 is a flowchart of an equipment configuration method for a simulated chess piece character according to an exemplary embodiment of this application;

FIG. 4 is a flowchart of an equipment configuration method for a simulated chess piece character according to an exemplary embodiment of this application;

FIG. 5 is a flowchart of an equipment configuration method for a simulated chess piece character according to an exemplary embodiment of this application;

FIG. 6 is a flowchart of an equipment configuration method for a simulated chess piece character according to an exemplary embodiment of this application;

FIG. 7 is a flowchart of an equipment configuration method for a simulated chess piece character according to an exemplary embodiment of this application;

FIG. 8 is a block diagram of an equipment configuration apparatus for a simulated chess piece character according to an exemplary embodiment of this application; and

FIG. 9 is a schematic structural diagram of a computer device according to an exemplary embodiment of this application.

### DESCRIPTION OF EMBODIMENTS

To make the objectives, technical solutions, and advantages of this application clearer, the following further describes implementations of this application in detail with reference to the accompanying drawings. Exemplary embodiments are described in detail herein, and examples of the exemplary embodiments are shown in the accompanying drawings. When the following description involves the accompanying drawings, unless otherwise indicated, the same numerals in different accompanying drawings represent the same or similar elements. The implementations described in the following exemplary embodiments do not represent all implementations consistent with this application. On the contrary, the implementations are merely examples of apparatuses and methods that are described in detail in the appended claims and that are consistent with some aspects of this application.

The terms used in the present disclosure are for the purpose of describing specific embodiments only and are not intended to limit the present disclosure. The singular forms of “a” and “the” used in the present disclosure and the appended claims are intended to include the plural forms as well, unless the context clearly indicates otherwise. The term “and/or” used herein indicates and includes any or all possible combinations of one or more associated listed items.

Although the terms such as “first”, “second”, and “third” may be used in the present disclosure to describe various information, the information is not limited to these terms. These terms are merely used to distinguish between information of the same type.

First, several terms involved in the embodiments of this application are introduced.

Auto chess: Auto chess refers to a chess game in which “chess pieces” are pre-arranged before a chess battle, and during the battle, the “chess pieces” may automatically play against each other according to the pre-arrangement. “Chess pieces” are usually represented by chess piece characters. During the battle, the chess piece characters automatically release various skills to battle. Battles are usually turn-based. When all “chess pieces” of one side in the battle are killed (that is, life values of the chess piece characters are reduced to zero), this side is the loser of the battle.

Chessboard: Chessboard refers to an area in a battle interface of an auto chess game used to prepare for and conduct battles. The chessboard may be any one of a two-dimensional virtual chessboard, a 2.5-dimensional virtual chessboard, and a three-dimensional virtual chessboard. This is not limited in this application.

In an embodiment, the chessboard is divided into a battle area and a preparation area. The battle area includes several battle chess grids of the same size, and the battle chess grids are configured to place battle chess pieces for the battle during the battle. The preparation area includes several preparation chess grids, and the preparation chess grids are configured to place preparation chess pieces. The preparation chess pieces do not participate in the battle during the battle and may be dragged and placed in the battle area in the preparation phase.

Regarding an arrangement manner of chess grids in the battle area, in some embodiments, the battle area includes n (rows)×m (columns) battle chess grids. For example, n is an integer multiple of 2, and two adjacent rows of chess grids are aligned, or two adjacent rows of chess grids are staggered. In addition, the battle area is evenly divided into two parts according to rows, that is, a self-battle area and an enemy battle area. Users participating in the battle are located on the upper and lower sides of the battle interface. In the preparation phase, users can only place chess pieces in the self-battle area. In other embodiments, the battle area is evenly divided into two parts according to columns, that is, a self-battle area and an enemy battle area, and users participating in the battle are located on the left and right sides of the battle interface. A shape of the chessboard may be any one of square, rectangle, circle, and hexagon. The shape of the chessboard is not limited in the embodiments of this application.

In some embodiments, the battle chess grid is always displayed on the chessboard. In other embodiments, the battle chess grid is displayed when the user arranges the battle chess pieces and after the battle chess pieces are placed on the chess grid, the battle chess grid is not displayed.

Chess piece character: a chess piece character refers to a “chess piece” placed on the chessboard in the auto chess game. “Chess pieces” are usually represented by chess piece characters.

In some embodiments, chess piece characters may be distinguished according to character attributes. The chess piece characters include a battle chess piece character and a candidate chess piece character in a candidate chess piece character list (that is, a candidate chess piece character in a virtual store), where the battle chess piece character includes a chess piece character located in the battle area and a chess piece character located in the preparation area. The chess piece character may be a virtual chess piece, a virtual character, a virtual animal, an animation character, or the like, and the chess piece character may be displayed using a three-dimensional model. Candidate chess piece characters may be combined with existing battle chess piece characters of users to trigger buff battle effects, or may participate in chess battles alone as chess piece characters.

In an embodiment, a position of the battle chess piece character on the chessboard may be changed. In the preparation phase, a user may adjust a position of the chess piece character in the battle area, adjust a position of the chess piece character in the preparation area, move the chess piece character in the battle area to the preparation area (when there is an idle preparation chess grid in the preparation area), or move the chess piece character in the preparation area to the battle area. In the battle phase, the position of the chess piece character in the preparation area may also be adjusted.

In an embodiment, the position of the chess piece character in the battle area in the battle phase is different from that in the preparation phase. For example, in the battle phase, the chess piece character may automatically move from the self-battle area to the enemy battle area and attack an enemy chess piece character. Alternatively, the chess piece character may automatically move from a position A in the self-battle area to a position B in the self-battle area. In addition, in the preparation phase, the chess piece character may only be set in the self-battle area, and a chess piece character set by the enemy is invisible on the chessboard. Regarding a method of obtaining a battle chess piece character, in some embodiments, the user may purchase a chess piece character in the preparation phase in a game.

In some embodiments, chess piece characters may be distinguished by accounts. In this case, chess piece characters include a main chess piece character controlled by a player account of a human player and a simulated chess piece character controlled by a robot account of a non-human player. Numbers of main chess piece characters and simulated chess piece characters in a game are not specifically limited in the embodiments of this application.

In some embodiments, in addition to having “chess piece characters” for playing a game, both sides of a battle are also respectively provided with virtual characters to represent users participating in the battle. The users herein include human players and non-human players. The virtual character cannot be moved to the battle area or the preparation area as a “chess piece”. The virtual character is also provided with a life value (or a blood volume). The life value of the virtual character is reduced (the battle fails) or stays unchanged (the battle succeeds) according to a result of each battle. When the life value of the virtual character is reduced to zero, the user corresponding to the virtual character exits the battle, and the remaining users continue to battle. The virtual characters representing the users participating in the battle in the game include a main virtual character corresponding to the player account of the human player and a simulated virtual character corresponding to the robot account of the non-human player.

In this application, a prompt interface or a pop-up window may be displayed, or voice prompt information may be outputted before collecting user-related data and when collecting user-related data. The prompt interface, the pop-up window, or the voice prompt information is configured for prompting the user that user-related data is currently being collected. In this way, in this application, related steps of obtaining the user-related data only start to be executed after obtaining a confirmation operation of the user on the prompt interface or the pop-up window. Otherwise (that is, the confirmation operation of the user on the prompt interface or the pop-up window is not obtained), the related steps of obtaining the user-related data are ended, that is, the user-related data is not obtained. In other words, all user data collected in this application is collected with the consent and authorization of the user, and the collection, usage, and processing of user-related data need to comply with the relevant laws, regulations, and standards of relevant countries and regions.

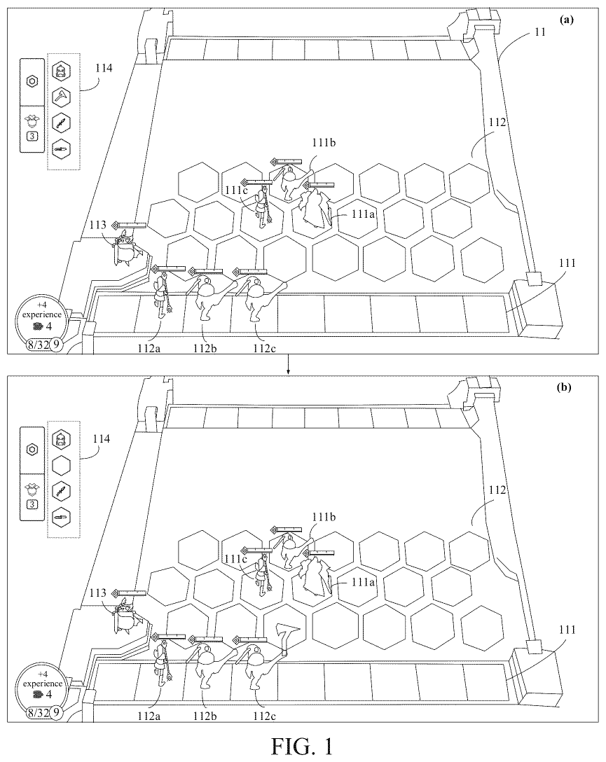

FIG. 1 is a schematic diagram of an equipment configuration method for a simulated chess piece character. This method may be performed by a computer device, and the computer device may be a terminal or a server.

For example, as shown in FIG. 1, a battle interface is displayed in a user interface. A battle chessboard 11 in the battle interface includes a preparation area 111 and a battle area 112. The battle area 112 includes 3×7 battle chess grids, a shape of the chess grid is hexagonal, and two adjacent rows of chess grids are staggered. The preparation area 111 includes 9 preparation chess grids.

As shown in (a) of FIG. 1, a first battle simulated chess piece character 111a, a second battle simulated chess piece character 111b, and a third battle simulated chess piece character 111c are displayed in the battle area 112, and a first preparation simulated chess piece character 112a, a second preparation simulated chess piece character 112b, and a third preparation simulated chess piece character 112c are displayed in the preparation area 111. A robot account 113 is displayed next to the battle area 112 and the preparation area 111.

The battle chessboard includes at least one simulated chess piece character, and the simulated chess piece character is a chess piece character controlled by the robot account 113. The simulated chess piece character may be at least one of the first battle simulated chess piece character 111a, the second battle simulated chess piece character 111b, the third battle simulated chess piece character 111c, the first preparation simulated chess piece character 112a, the second preparation simulated chess piece character 112b, and the third preparation simulated chess piece character 112c.

The robot account 113 refers to an account corresponding to a non-human player (artificial intelligence).

For example, in response to a lineup configuration of simulated chess piece characters in a current game, the computer device displays recommended equipment's corresponding to the simulated chess piece characters, and in response to that a simulated chess piece character meets an equipping condition, displays the simulated chess piece character equipped with recommended equipment.

The lineup configuration refers to at least one of a type, a number, and a character attribute configuration of the simulated chess piece character in this game.

The lineup configuration includes at least one of the simulated chess piece character displayed on the battle chessboard and a simulated chess piece character that the robot account has not obtained yet.

The equipping condition refers to a condition of matching between a simulated chess piece character and corresponding recommended equipment.

In an embodiment, the equipping condition includes that a score of matching between at least one of a name, a type, a number, and a character attribute of the simulated chess piece character and at least one of a name, a type, a number, and an equipment attribute of the recommended equipment is greater than a threshold.

For example, a simulated chess piece character with an offensive character attribute and offensive equipment meet the equipping condition; and a simulated chess piece character with a healing character attribute and healing equipment meet the equipping condition.

The recommended equipment is recommended equipment obtained based on the simulated chess piece character in the lineup configuration.

For example, the lineup configuration of simulated chess piece characters in a current game is 5 simulated chess piece characters, and each simulated chess piece character is equipped with 3 equipment's. In this case, a number of recommended equipment's obtained based on the simulated chess piece characters in the lineup configuration is 15.

For example, based on character attribute information of the simulated chess piece character in the lineup configuration and candidate equipment attribute information of candidate equipment in a candidate equipment set, the computer device obtains the recommended equipment corresponding to the simulated chess piece character.

The character attribute information refers to attribute information corresponding to the simulated chess piece character in the lineup configuration, for example, at least one of a healing attribute, an attack attribute, a defense attribute, a movement attribute, and a control attribute.

The candidate equipment attribute information refers to attribute information corresponding to the candidate equipment, for example, at least one of attack equipment, healing equipment, defense equipment, movement equipment, and control equipment.

In an embodiment, the computer device traverses candidate equipment's in the candidate equipment set, and when the candidate equipment is first selectable equipment of the simulated chess piece character, determines the candidate equipment as the recommended equipment corresponding to the simulated chess piece character;

when the candidate equipment is not the first selectable equipment of the simulated chess piece character, and instead is second selectable equipment of the simulated chess piece character, determines the candidate equipment as the recommended equipment corresponding to the simulated chess piece character; and

when the candidate equipment is neither the first selectable equipment nor the second selectable equipment, calculates, based on the character attribute value and the candidate equipment attribute value, a score of matching between candidate equipment and the simulated chess piece character, and determines candidate equipment with the highest score of matching as the recommended equipment corresponding to the simulated chess piece character.

The score of matching refers to a score of matching calculated based on the candidate equipment attribute value of the candidate equipment and the character attribute value of the simulated chess piece character.

The candidate equipment attribute value refers to a representative value obtained by analyzing the attribute and the effect of the candidate equipment.

The character attribute value refers to a representative value obtained by analyzing the attribute and the effect of the simulated chess piece character.

The first selectable equipment is equipment suitable for equipping on the simulated chess piece character in the current lineup configuration, and specifically may be equipment whose score of matching with the simulated chess piece character in the current lineup configuration is greater than a first threshold. Alternatively, the first selectable equipment refers to equipment that allows the simulated chess piece character to maximize potential in the current lineup configuration. For example, in the lineup configuration of a team battle, the first selectable equipment is equipment with a killing range greater than a preset killing range or equipment with a killing value greater than a killing threshold. Alternatively, the first selectable equipment refers to at least some of equipment's selected in advance.

The second selectable equipment is equipment suitable for equipping on the simulated chess piece character in the current lineup configuration, and specifically may be equipment whose score of matching with the simulated chess piece character in the current lineup configuration is greater than a second threshold, for example, equipment with the same attribute as the simulated chess piece character. Alternatively, the second selectable equipment refers to at least some of equipment's selected in advance. The second selectable equipment and the first selectable equipment may be different equipment's.

For example, the first threshold and the second threshold are thresholds of different values, and the first threshold may be larger than the second threshold. The score of matching between the equipment and the simulated chess piece character may be a score of matching between at least one of a name, a type, a number, and an equipment attribute of the equipment and at least one of a name, a type, a number, and a character attribute of the simulated chess piece character.

In an embodiment, the score of matching between at least one of a name, a type, a number, and an equipment attribute of each equipment and at least one of a name, a type, a number, and a character attribute of the simulated chess piece character may be preset and correspondingly stored. Alternatively, the score of matching between at least one of a name, a type, a number, and an equipment attribute of each equipment and at least one of a name, a type, a number, and a character attribute of the simulated chess piece character may be determined by a pre-trained scoring model. For example, at least one of a name, a type, a number, and an equipment attribute of equipment and at least one of a name, a type, a number, and a character attribute of the simulated chess piece character are inputted into the scoring model, and the score of matching between the equipment and the simulated chess piece character is outputted by the scoring model.

For example, the computer device sequentially selects equipment from the candidate equipment set for the simulated chess piece character based on the equipment selection priority information of the simulated chess piece character.

For example, based on the equipment selection priority information of the simulated chess piece character, the computer device sequentially selects equipment from the candidate equipment set for the simulated chess piece character in descending order of priorities.

For example, when the recommended equipment is obtained, the computer device pre-allocates the recommended equipment to a simulated chess piece character based on the lineup configuration of the simulated chess piece characters, to obtain a pre-allocation result of the simulated chess piece character equipped with the recommended equipment. When the simulated chess piece character meets the equipping condition, the computer device equips the simulated chess piece character with the recommended equipment based on the pre-allocation result.

The pre-allocation result is a pre-configuration result of recommended equipment's with which the computer device may equip each of all the simulated chess piece characters in the lineup configuration based on the recommended equipment's. All the simulated chess piece characters in the lineup configuration include at least one of the simulated chess piece character displayed on the chessboard and a simulated chess piece character that the robot account has not obtained yet.

In an embodiment, the recommended equipment may be pre-allocated to the simulated chess piece character in an exhaustive manner.

In an embodiment, when the recommended equipment is the first selectable equipment of the simulated chess piece character, the computer device allocates the recommended equipment to the simulated chess piece character;

when the recommended equipment is not the first selectable equipment of the simulated chess piece character, and instead is the second selectable equipment of the simulated chess piece character, allocates the recommended equipment to the simulated chess piece character; and

when the recommended equipment is neither the first selectable equipment nor the second selectable equipment, calculates, based on the character attribute value and the recommended equipment attribute value, a score of allocating the recommended equipment to the simulated chess piece character, and allocates the recommended equipment to the simulated chess piece character with the highest score of allocating.

The score of allocating refers to a score of matching calculated based on the recommended equipment attribute value of the recommended equipment and the character attribute value of the simulated chess piece character.

The recommended equipment attribute value refers to a representative value obtained by analyzing the attribute and the effect of the recommended equipment.

In a scenario in which the candidate equipment is selected as the recommended equipment, the value of the recommended equipment attribute value is the same as the value of the candidate equipment attribute value.

For example, when the simulated chess piece character is displayed on the battle chessboard, the corresponding simulated chess piece character is equipped with the recommended equipment based on the pre-allocation result; and

when the simulated chess piece character is not displayed on the battle chessboard, a score of matching between the simulated chess piece character and the recommended equipment is calculated based on the character attribute value corresponding to the simulated chess piece character and the recommended equipment attribute value corresponding to the recommended equipment, and the simulated chess piece character with the highest score of matching is equipped with the recommended equipment.

For example, as shown in (b) of FIG. 1, recommended equipment “battle axe” displayed in an equipment display area 114 is not first selectable equipment of the third preparation simulated chess piece character 112c, and instead is second selectable equipment of the third preparation simulated chess piece character 112c. In this case, the recommended equipment “battle axe” is allocated to the third preparation simulated chess piece character 112c. When the third preparation simulated chess piece character 112c is displayed on the battle chessboard, the second preparation simulated chess piece character 112b is equipped with the recommended equipment “battle axe”. When the third preparation simulated chess piece character 112c is displayed on the battle chessboard, the third preparation simulated chess piece character 112c is equipped with the recommended equipment “battle axe” based on the pre-allocation result.

For example, the lineup configuration of simulated chess piece characters in this game is 5 simulated chess piece characters, but currently only 3 simulated chess piece characters have been obtained and 2 simulated chess piece characters have not been obtained. In this case, the computer device selects equipment based on the lineup configuration of the simulated chess piece characters in this game, and obtains recommended equipment's corresponding to the simulated chess piece characters. For example, if each of the 5 simulated chess piece characters is equipped with 3 recommended equipment's, 15 recommended equipment's corresponding to the 5 simulated chess piece characters are obtained.

The computer device pre-allocates the selected recommended equipment's to the 5 simulated chess piece characters, and obtains the pre-allocation result of the simulated chess piece characters equipped with the recommended equipment's, that is, the computer device pre-allocates for the 3 simulated chess piece characters that have been obtained and the 2 simulated chess piece characters that have not been obtained. In the allocation process, when the simulated chess piece character is displayed on the battle chessboard, the computer device equips the corresponding simulated chess piece character with the obtained recommended equipment based on the pre-allocation result; and when the simulated chess piece character is not displayed on the battle chessboard, calculates, based on the character attribute value corresponding to the simulated chess piece character and the recommended equipment attribute value corresponding to the recommended equipment, a score of matching between the simulated chess piece character and the recommended equipment, and equips, with the recommended equipment, a simulated chess piece character with the highest score of matching.

For example, when equipment A is obtained, the equipment A is allocated to the simulated chess piece character a according to the pre-allocation result. However, the simulated chess piece character a has not been obtained yet on the battle chessboard at this time. In this case, a score of matching between each simulated chess piece character and the equipment A is calculated, and a score of matching of the simulated chess piece character b is the highest. In this case, it is known that it is most suitable to equip the simulated chess piece character b with the equipment A. Therefore, the simulated chess piece character b is first equipped with the equipment A. Later, after the simulated chess piece character a is obtained, the equipment A on the simulated chess piece character b is transferred to the simulated chess piece character a.

Not all the 15 recommended equipment's have been obtained, and instead at least some of the 15 recommended equipment's are selected first, and then all the 15 recommended equipment's are gradually obtained in the game.

In conclusion, in the equipment configuration method for a simulated chess piece character provided in this embodiment, the computer device displays a battle chessboard, the battle chessboard including at least one simulated chess piece character, and the simulated chess piece character being a chess piece character controlled by a robot account; in response to a lineup configuration of the simulated chess piece character in this game, displays recommended equipment corresponding to the simulated chess piece character; and in response to that the simulated chess piece character meets an equipping condition, displays the simulated chess piece character equipped with the recommended equipment. In this application, recommended equipment's corresponding to all simulated chess piece characters are obtained at once based on the lineup configuration of the simulated chess piece characters in this game, and in the case that the simulated chess piece character meets the equipping condition, the simulated chess piece character is equipped with the recommended equipment. This avoids a process of calculating, each time a new piece of equipment is obtained, the matching between the new equipment and each simulated chess piece character, which reduces a computing amount and reduces the processing power consumption of the computer device.

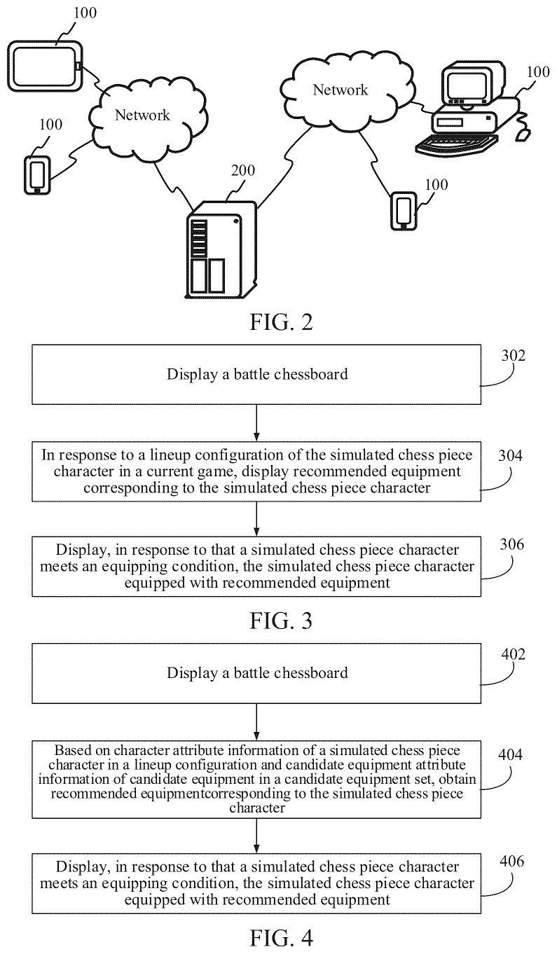

FIG. 2 is a schematic architectural diagram of a computer system according to an embodiment of this application. The computer system may include: a terminal 100 and a server 200.

The terminal 100 may be an electronic device such as a mobile phone, a tablet computer, a vehicle-mounted terminal (a car machine), a wearable device, a personal computer (PC), a palm image recognition device, a palm image recognition appliance, an in-vehicle terminal, an aircraft, or an unmanned vending machine. A client running a target application program may be installed in the terminal 100. This is not limited in this application. In addition, in this application, the form of the target application program is not limited, and includes but is not limited to an application program (App), a mini program, or the like installed in the terminal 100, and may also be web pages.

The server 200 may be an independent physical server, or a server cluster composed of multiple physical servers or a distributed system, or may be a cloud server that provides basic cloud computing services such as cloud computing services, cloud databases, cloud computing, cloud functions, cloud storage, and network services, cloud communications, middleware services, domain name services, security services, content delivery networks (CDN), big data, and artificial palmtop image recognition platforms. The server 200 may be a backend server of the target application program, and is configured to provide background services for clients of the target application program.

The cloud technology refers to a hosting technology that combines a series of resources such as hardware, software, and networks in a wide area network or a local area network to perform data calculation, storage, processing, and sharing. The cloud technology is a general term for a network technology, an information technology, an integration technology, a management platform technology, an application technology, and the like applied based on the business mode of cloud computing, and may form a resource pool used on demand flexibly and conveniently. The cloud computing technology will become an important support. The background service of a technical network system requires many computing and storage resources, for example, video websites, image websites, and more portal websites. With rapid development and application of the Internet industry, in the future, each item may have an identifier, all identifiers need to be transmitted to a background system for logical processing, data at different levels will be processed separately, and all types of industry data require powerful system support. This can be implemented only through cloud computing.

In some embodiments, the server 200 may also be implemented as a node in the blockchain system. The blockchain is a new application model of computer technologies such as distributed data storage, point-to-point transmission, consensus mechanism, and encryption algorithm. A blockchain is essentially a decentralized database and is a string of data blocks associated with cryptographic methods. Each data block includes a batch of network transaction information and is used to verify the validity of information thereof (anti-counterfeiting) and generate a next block. A blockchain may include a blockchain underlying platform, a platform product service layer, and an application service layer.

The terminal 100 may communicate with the server 200 by using a network, for example, a wired or wireless network.

Steps of the equipment configuration method for a simulated chess piece character provided in the embodiments of this application may be executed by a computer device. The computer device refers to an electronic device with data calculation, processing, and storage capabilities. Taking the implementation environment of the solution shown in FIG. 2 as an example, the terminal 100 may execute the equipment configuration method for a simulated chess piece character (for example, a client of a target application program installed to run in the terminal 100 performs the equipment configuration method for a simulated chess piece character), or the server 200 may perform the equipment configuration method for a simulated chess piece character, or the terminal 100 and the server 200 may perform the equipment configuration method for a simulated chess piece character in interactive cooperation. This is not limited in this application.

FIG. 3 is a flowchart of an equipment configuration method for a simulated chess piece character according to an exemplary embodiment of this application. This method may be performed by a computer device, and the computer device may be the terminal 100 or the server 200 in FIG. 2. This method includes:

### Step 302: Display a Battle Chessboard.

A chessboard refers to an area in a battle interface of an auto chess game used to prepare for and conduct battles. The chessboard may be any one of a two-dimensional virtual chessboard, a 2.5-dimensional virtual chessboard, and a three-dimensional virtual chessboard. This is not limited in this application.

The chessboard is divided into a battle area and a preparation area. The battle area includes several battle chess grids of the same size, and the battle chess grids are configured to place battle chess pieces for the battle during the battle. The preparation area includes several preparation chess grids, and the preparation chess grids are configured to place preparation chess pieces. The preparation chess pieces do not participate in the battle during the battle and may be dragged and placed in the battle area during the preparation phase.

For example, as shown in (a) of FIG. 1, a battle chessboard 11 in the battle interface includes a preparation area 111 and a battle area 112. The battle area 112 includes several battle chess grids of the same size, for example, the battle area 112 includes 3×7 battle chess grids. The chess grids are hexagonal, and two adjacent rows of chess grids are staggered. The battle chess grids are configured to place the battle chess pieces for the battle during the battle. The preparation area 111 includes several preparation chess grids, for example, the preparation area 111 includes 9 preparation chess grids, and the preparation chess grids are configured to place preparation chess pieces. The preparation chess pieces do not participate in the battle during the battle and may be dragged and placed in the battle area during the preparation phase.

Regarding an arrangement manner of chess grids in the battle area, in some embodiments, the battle area includes n (rows)×m (columns) battle chess grids. For example, n is an integer multiple of 2, and two adjacent rows of chess grids are aligned, or two adjacent rows of chess grids are staggered. In addition, the battle area is evenly divided into two parts according to rows, that is, a self-battle area and an enemy battle area. Users participating in the battle are located on the upper and lower sides of the battle interface. In the preparation phase, users may only place chess pieces in the self-battle area. In other embodiments, the battle area is evenly divided into two parts according to columns, that is, a self-battle area and an enemy battle area, and users participating in the battle are located on the left and right sides of the battle interface. A shape of the chessboard may be any one of square, rectangle, circle, and hexagon. The shape of the chessboard is not limited in the embodiments of this application.

For example, the computer device displays a battle chessboard, and the battle chessboard includes at least one simulated chess piece character controlled by a robot account. In an embodiment, the battle chessboard further includes at least one main chess piece character controlled by a player account.

The simulated chess piece character is a chess piece character controlled by a robot account. The robot account is an account of a non-human player.

The main chess piece character is a chess piece character controlled by a player account. The player account refers to an account of a human player.

In an embodiment, in the same game, chess piece characters in the battle chessboard may include both a main chess piece character controlled by a player account of a human player and a simulated chess piece character controlled by a robot account. Numbers of main chess piece characters and simulated chess piece characters in a game are not specifically limited in the embodiments of this application. That is, in the same game, there may be only one main chess piece character controlled by the player account of the human player, and the remaining characters are all simulated chess piece characters controlled by the robot account.

The robot account corresponds to a non-human player, which is also referred to as an AI player and a computer player.

In some embodiments, the robot account may be a “human-like player” controlled based on an algorithm or an AI model. The robot account may have the ability to perceive a series of operations of a human player and interact with the operations, such as: jump and run. The behavior of the robot account is unpredictable. The robot account may learn autonomously through AI and evolve new behaviors by sensing changes in the surrounding environment. Alternatively, the robot account makes a decision based on a tree of strategies to determine a correct behavior that needs to be performed. When a trigger condition is received, the tree of strategies is traversed to determine a function for performing a specific operation. The tree of strategies refers to that all possible strategies that meet all requirements are arranged in one tree. This tree is a recursive tree used to instruct the robot account to perform specific operations.

Step 304: In response to a lineup configuration of the simulated chess piece character in this game, display recommended equipment corresponding to the simulated chess piece character.

The lineup configuration refers to at least one of a name, a type, a number, and a character attribute configuration of the simulated chess piece character in this game.

The lineup configuration includes at least one of the simulated chess piece character displayed on the battle chessboard and a simulated chess piece character that the robot account has not obtained yet.

The recommended equipment is recommended equipment obtained based on the simulated chess piece character in the lineup configuration.

For example, the lineup configuration of simulated chess piece characters in a current game is 5 simulated chess piece characters, and each simulated chess piece character is equipped with 3 equipment's. In this case, a number of recommended equipment's obtained based on the simulated chess piece characters in the lineup configuration is 15.

For example, a type of the recommended equipment may be at least one of attack equipment, healing equipment, defense equipment, movement equipment, and control equipment.

For example, in response to the lineup configuration of the simulated chess piece characters in this game, the computer device displays recommended equipment's corresponding to the simulated chess piece characters.

Step 306: Display, in Response to that the Simulated Chess Piece Character Meets an Equipping Condition, the Simulated Chess Piece Character Equipped with the Recommended Equipment.

For example, in response to that the simulated chess piece character meets the equipping condition, the computer displays the simulated chess piece character equipped with the recommended equipment.

The equipping condition refers to a condition of matching between a simulated chess piece character and corresponding recommended equipment.

In an embodiment, the equipping condition includes that a score of matching between at least one of a name, a type, a number, and a character attribute of the simulated chess piece character and at least one of a name, a type, a number, and an equipment attribute of the recommended equipment is greater than a threshold.

In an embodiment, the equipping condition may be set with multiple thresholds. For example, a score of matching between the name of the simulated chess piece character and the name of the recommended equipment may be set with a name threshold, a score of matching between the type of the simulated chess piece character and the type of recommended equipment may be set with a type threshold, a score of matching between the number of simulated chess piece characters and the number of recommended equipment's may be set with a number threshold, and a score of matching between the character attribute of the simulated chess piece character and the equipment attribute of the recommended equipment may be set with an attribute threshold.

In an embodiment, the equipping condition refers to a preset condition used to determine whether the simulated chess piece character may be equipped with or suitable to be equipped with the recommended equipment. When the preset condition is met, the simulated chess piece character may be equipped with or is suitable to be equipped with the recommended equipment. When the preset condition is not met, the simulated chess piece character cannot be equipped with or is not suitable to be equipped with the recommended equipment.

For example, a simulated chess piece character with an offensive character attribute and offensive equipment meet the equipping condition; and a simulated chess piece character with a healing character attribute and healing equipment meet the equipping condition.

In conclusion, in the equipment configuration method for a simulated chess piece character provided in this embodiment, the computer device displays a battle chessboard, the battle chessboard including at least one simulated chess piece character, and the simulated chess piece character being a chess piece character controlled by a robot account; in response to a lineup configuration of the simulated chess piece character in this game, displays recommended equipment corresponding to the simulated chess piece character; and in response to that the simulated chess piece character meets an equipping condition, displays the simulated chess piece character equipped with the recommended equipment. In this application, recommended equipment's corresponding to all simulated chess piece characters are obtained at once based on the lineup configuration of the simulated chess piece characters in this game, and in the case that the simulated chess piece character meets the equipping condition, the simulated chess piece character is equipped with the recommended equipment. This avoids a process of calculating, each time a new piece of equipment is obtained, the matching between the new equipment and each simulated chess piece character, which reduces a computing amount and reduces the processing power consumption of the computer device.

FIG. 4 is a flowchart of an equipment configuration method for a simulated chess piece character according to an exemplary embodiment of this application. This method may be performed by a computer device, and the computer device may be the terminal 100 or the server 200 in FIG. 2. This method includes:

### Step 402: Display a Battle Chessboard.

A chessboard refers to an area in a battle interface of an auto chess game used to prepare for and conduct battles. The chessboard may be any one of a two-dimensional virtual chessboard, a 2.5-dimensional virtual chessboard, and a three-dimensional virtual chessboard. This is not limited in this application.

The chessboard is divided into a battle area and a preparation area. The battle area includes several battle chess grids of the same size, and the battle chess grids are configured to place battle chess pieces for the battle during the battle. The preparation area includes several preparation chess grids, and the preparation chess grids are configured to place preparation chess pieces. The preparation chess pieces do not participate in the battle during the battle and may be dragged and placed in the battle area during the preparation phase.

Regarding an arrangement manner of chess grids in the battle area, in some embodiments, the battle area includes n (rows)×m (columns) battle chess grids. For example, n is an integer multiple of 2, and two adjacent rows of chess grids are aligned, or two adjacent rows of chess grids are staggered. In addition, the battle area is evenly divided into two parts according to rows, that is, a self-battle area and an enemy battle area. Users participating in the battle are located on the upper and lower sides of the battle interface. In the preparation phase, users may only place chess pieces in the self-battle area. In other embodiments, the battle area is evenly divided into two parts according to columns, that is, a self-battle area and an enemy battle area, and users participating in the battle are located on the left and right sides of the battle interface. A shape of the chessboard may be any one of square, rectangle, circle, and hexagon. The shape of the chessboard is not limited in the embodiments of this application.

For example, the computer device displays a battle chessboard, and the battle chessboard includes at least one simulated chess piece character controlled by a robot account. In an embodiment, the battle chessboard further includes at least one main chess piece character controlled by a player account.

The simulated chess piece character is a chess piece character controlled by a robot account. The robot account is an account of a non-human player.

The main chess piece character is a chess piece character controlled by a player account. The player account refers to an account of a human player.

In an embodiment, in the same game, chess piece characters in the battle chessboard may include both a main chess piece character controlled by a player account of a human player and a simulated chess piece character controlled by a robot account. Numbers of main chess piece characters and simulated chess piece characters in a game are not specifically limited in the embodiments of this application. That is, in the same game, there may be only one main chess piece character controlled by the player account of the human player, and the remaining characters are all simulated chess piece characters controlled by the robot account.

The robot account corresponds to a non-human player, which is also referred to as an AI player and a computer player.

In some embodiments, the robot account may be a “human-like player” controlled based on an algorithm or an AI model. The robot account may have the ability to perceive a series of operations of a human player and interact with the operations, such as: jump and run. The behavior of the robot account is unpredictable. The robot account may learn autonomously through AI and evolve new behaviors by sensing changes in the surrounding environment. Alternatively, the robot account makes a decision based on a tree of strategies to determine a correct behavior that needs to be performed. When a trigger condition is received, the tree of strategies is traversed to determine a function for performing a specific operation. The tree of strategies refers to that all possible strategies that meet all requirements are arranged in one tree. This tree is a recursive tree used to instruct the robot account to perform specific operations.

Step 404: Based on Character Attribute Information of a Simulated Chess Piece Character in a Lineup Configuration and Candidate Equipment Attribute Information of Candidate Equipment in a Candidate Equipment Set, Obtain Recommended Equipment Corresponding to the Simulated Chess Piece Character.

The lineup configuration refers to at least one of a name, a type, a number, and a character attribute configuration of the simulated chess piece character in this game.

The lineup configuration includes at least one of the simulated chess piece character displayed on the battle chessboard and a simulated chess piece character that the robot account has not obtained yet.

The recommended equipment is recommended equipment obtained based on the simulated chess piece character in the lineup configuration.

In an embodiment, recommended equipment includes occupation transfer tokens and regular equipment.

The occupation transfer token is used to change a job attribute of the simulated chess piece character. For example, by equipping with the occupation transfer token, the job attribute of the simulated chess piece character is changed from “peasant” to “gardener”.

For example, based on character attribute information of the simulated chess piece character in the lineup configuration and candidate equipment attribute information of candidate equipment in a candidate equipment set, the computer device obtains the recommended equipment corresponding to the simulated chess piece character.

The character attribute information refers to attribute information corresponding to the simulated chess piece character in the lineup configuration, for example, at least one of a healing attribute, an attack attribute, a defense attribute, a movement attribute, and a control attribute.

The candidate equipment attribute information refers to attribute information corresponding to the candidate equipment, for example, at least one of attack equipment, healing equipment, defense equipment, movement equipment, and control equipment.

In an embodiment, a computer device traverses candidate equipment's in the candidate equipment set, and when the candidate equipment is first selectable equipment of the simulated chess piece character, determines the candidate equipment as the recommended equipment corresponding to the simulated chess piece character;
when the candidate equipment is not the first selectable equipment of the simulated chess piece character, and instead is second selectable equipment of the simulated chess piece character, determines the candidate equipment as the recommended equipment corresponding to the simulated chess piece character; and
when the candidate equipment is neither the first selectable equipment nor the second selectable equipment, calculates, based on the character attribute value and the candidate equipment attribute value, a score of matching between candidate equipment and the simulated chess piece character, and determines candidate equipment with the highest score of matching as the recommended equipment corresponding to the simulated chess piece character.

The score of matching refers to a score of matching calculated based on the candidate equipment attribute value of the candidate equipment and the character attribute value of the simulated chess piece character.

A calculation formula of the score of matching may be expressed as:

p₁=α*k₁(1+x₁)*x₂.

In the formula, p₁ is a score of matching, α is a basic battle strength of a simulated chess piece character, k₁ is a coefficient, x₁ is an attribute enhancing value of a simulated chess piece character (or referred to as a character attribute value), and x₂ is an amplification factor of a candidate equipment attribute (or referred to as a candidate equipment attribute value).

The candidate equipment attribute value refers to a representative value obtained by analyzing the attribute and the effect of the candidate equipment.

The character attribute value refers to a representative value obtained by analyzing the attribute and the effect of the simulated chess piece character.

The first selectable equipment is equipment suitable for equipping on the simulated chess piece character in the current lineup configuration, and specifically may be equipment whose score of matching with the simulated chess piece character in the current lineup configuration is greater than a first threshold. Alternatively, the first selectable equipment refers to equipment that allows the simulated chess piece character to maximize potential in the current lineup configuration. For example, in the lineup configuration of a team battle, the first selectable equipment is equipment with a killing range greater than a preset killing range or equipment with a killing value greater than a killing threshold. Alternatively, the first selectable equipment refers to at least some of equipment's selected in advance.

The second selectable equipment is equipment suitable for equipping on the simulated chess piece character in the current lineup configuration, and specifically may be equipment whose score of matching with the simulated chess piece character in the current lineup configuration is greater than a second threshold, for example, equipment with the same attribute as the simulated chess piece character. Alternatively, the second selectable equipment refers to at least some of equipment's selected in advance. The second selectable equipment and the first selectable equipment may be different equipment's.

For example, the first threshold and the second threshold are thresholds of different values, and the first threshold may be larger than the second threshold. The score of matching between the equipment and the simulated chess piece character may be a score of matching between at least one of a name, a type, a number, and an equipment attribute of the equipment and at least one of a name, a type, a number, and a character attribute of the simulated chess piece character.

In an embodiment, the score of matching between at least one of a name, a type, a number, and an equipment attribute of each equipment and at least one of a name, a type, a number, and a character attribute of the simulated chess piece character may be preset and correspondingly stored. Alternatively, the score of matching between at least one of a name, a type, a number, and an equipment attribute of each equipment and at least one of a name, a type, a number, and a character attribute of the simulated chess piece character may be determined by a pre-trained scoring model. For example, at least one of a name, a type, a number, and an equipment attribute of equipment and at least one of a name, a type, a number, and a character attribute of the simulated chess piece character are inputted into the scoring model, and the score of matching between the equipment and the simulated chess piece character is outputted by the scoring model.

For example, the lineup configuration of simulated chess piece characters in this game is 5 simulated chess piece characters, but currently only 3 simulated chess piece characters have been obtained and 2 simulated chess piece characters have not been obtained. In this case, the computer device selects equipment based on the lineup configuration of the simulated chess piece characters in this game, and obtains recommended equipment's corresponding to the simulated chess piece characters. For example, if each of the 5 simulated chess piece characters is equipped with 3 recommended equipment's, 15 recommended equipment's corresponding to the 5 simulated chess piece characters are obtained. The computer device traverses the candidate equipment's in the candidate equipment set based on simulated chess piece characters in the lineup configuration, and determines the candidate equipment that meets an equipment selection condition as the recommended equipment.

Not all the 15 recommended equipment's have been obtained, and instead at least some of the 15 recommended equipment's are selected first, and then all the 15 recommended equipment's are gradually obtained in the game.

For example, the computer device sequentially selects equipment from the candidate equipment set for the simulated chess piece character based on the equipment selection priority information of the simulated chess piece character.

For example, based on the equipment selection priority information of the simulated chess piece character, the computer device sequentially selects equipment from the candidate equipment set for the simulated chess piece character in descending order of priorities.

In the equipment configuration method for a simulated chess piece character provided by this embodiment, the computer device obtains, based on the character attribute information of all simulated chess piece characters in the lineup configuration and the candidate equipment attribute information of the candidate equipment's in the candidate equipment set, the recommended equipment's corresponding to the simulated chess piece characters, and determines, from multiple dimensions, the recommended equipment's corresponding to the simulated chess piece characters. In this application, the recommended equipment's corresponding to all the simulated chess piece characters are obtained at once from multiple dimensions based on the lineup configuration of the simulated chess piece characters in this game. In this way, the computing amount is reduced and the processing power consumption of the computer device is reduced.

Step 406: In Response to that a Simulated Chess Piece Character Meets an Equipping Condition, Display the Simulated Chess Piece Character Equipped with Recommended Equipment.

For example, in response to that the simulated chess piece character meets the equipping condition, the computer displays the simulated chess piece character equipped with the recommended equipment.

The equipping condition refers to a condition of matching between a simulated chess piece character and corresponding recommended equipment.

In an embodiment, the equipping condition includes that a score of matching between at least one of a name, a type, a number, and a character attribute of the simulated chess piece character and at least one of a name, a type, a number, and an equipment attribute of the recommended equipment is greater than a threshold.

In an embodiment, the equipping condition may be set with multiple thresholds. For example, a score of matching between the name of the simulated chess piece character and the name of the recommended equipment may be set with a name threshold, a score of matching between the type of the simulated chess piece character and the type of recommended equipment may be set with a type threshold, a score of matching between the number of simulated chess piece characters and the number of recommended equipment's may be set with a number threshold, and a score of matching between the character attribute of the simulated chess piece character and the equipment attribute of the recommended equipment may be set with an attribute threshold.

In an embodiment, the equipping condition refers to a preset condition used to determine whether the simulated chess piece character may be equipped with or suitable to be equipped with the recommended equipment. When the preset condition is met, the simulated chess piece character may be equipped with or is suitable to be equipped with the recommended equipment. When the preset condition is not met, the simulated chess piece character cannot be equipped with or is not suitable to be equipped with the recommended equipment.

For example, a simulated chess piece character with an offensive character attribute and offensive equipment meet the equipping condition; and a simulated chess piece character with a healing character attribute and healing equipment meet the equipping condition.

For example, when the recommended equipment of the simulated chess piece character is obtained, the computer device pre-allocates the recommended equipment to the simulated chess piece character based on the lineup configuration of simulated chess piece characters, to obtain a pre-allocation result of the simulated chess piece character equipped with the recommended equipment. When the simulated chess piece character meets the equipping condition, the computer device equips the simulated chess piece character with the recommended equipment based on the pre-allocation result.

The pre-allocation result is a pre-configuration result of recommended equipment's with which the computer device may equip each of all the simulated chess piece characters in the lineup configuration based on the recommended equipment's. All the simulated chess piece characters in the lineup configuration include at least one of the simulated chess piece character displayed on the chessboard and a simulated chess piece character that the robot account has not obtained yet.

In an embodiment, the recommended equipment may be pre-allocated to the simulated chess piece character in an exhaustive manner.

In an embodiment, when the recommended equipment is the first selectable equipment of the simulated chess piece character, the computer device allocates the recommended equipment to the simulated chess piece character;

when the recommended equipment is not the first selectable equipment of the simulated chess piece character, and instead is the second selectable equipment of the simulated chess piece character, allocates the recommended equipment to the simulated chess piece character; and

when the recommended equipment is neither the first selectable equipment nor the second selectable equipment, calculates, based on the character attribute value and the recommended equipment attribute value, a score of allocating the recommended equipment to the simulated chess piece character, and allocates the recommended equipment to the simulated chess piece character with the highest score of allocating.

The score of allocating refers to a score of matching calculated based on the recommended equipment attribute value of the recommended equipment and the character attribute value of the simulated chess piece character.

A calculation formula of the score of matching may be expressed as:

$${p}_{2} = a * {k}_{2} ( 1 + {x}_{1} ) * {x}_{3} .$$

In the formula, p₂ is a score of matching, α is a basic battle strength of a simulated chess piece character, k₂ is a coefficient, x₁ is an attribute enhancing value of a simulated chess piece character (or referred to as a character attribute value), and x₃ is an amplification factor of a recommended equipment attribute (or referred to as a recommended equipment attribute value).

The recommended equipment attribute value refers to a representative value obtained by analyzing the attribute and the effect of the recommended equipment.

In a scenario in which the candidate equipment is selected as the recommended equipment, the value of the recommended equipment attribute value is the same as the value of the candidate equipment attribute value.

For example, when the simulated chess piece character is displayed on the battle chessboard, the corresponding simulated chess piece character is equipped with the recommended equipment based on the pre-allocation result; and

when the simulated chess piece character is not displayed on the battle chessboard, a score of matching between the simulated chess piece character and the recommended equipment is calculated based on the character attribute value corresponding to the simulated chess piece character and the recommended equipment attribute value corresponding to the recommended equipment, and the simulated chess piece character with the highest score of matching is equipped with the recommended equipment.

A calculation formula of the score of matching may be expressed as:

$${p}_{3} = a * {k}_{3} ( 1 + {x}_{1} ) * {x}_{3} .$$

In the formula, p₃ is a score of matching, α is a basic battle strength of a simulated chess piece character, k₃ is a coefficient, x₁ is an attribute enhancing value of a simulated chess piece character (or referred to as a character attribute value), and x₃ is an amplification factor of a recommended equipment attribute (or referred to as a recommended equipment attribute value).

For example, the computer device pre-allocates the selected recommended equipment's to the 5 simulated chess piece characters in the lineup configuration, and obtains the pre-allocation result of the simulated chess piece characters equipped with the recommended equipment's, that is, the computer device pre-allocates for the 3 simulated chess piece characters that have been obtained and the 2 simulated chess piece characters that have not been obtained. In the allocation process, when the simulated chess piece character is displayed on the battle chessboard, the computer device equips the corresponding simulated chess piece character with the obtained recommended equipment based on the pre-allocation result; and when the simulated chess piece character is not displayed on the battle chessboard, calculates, based on the character attribute value corresponding to the simulated chess piece character and the recommended equipment attribute value corresponding to the recommended equipment, a score of matching between the simulated chess piece character and the recommended equipment, and equips, with the recommended equipment, the simulated chess piece character with the highest score of matching.

For example, when equipment A is obtained, the equipment A is allocated to the simulated chess piece character a according to the pre-allocation result. However, the simulated chess piece character a has not been obtained yet on the battle chessboard at this time. In this case, a score of matching between a simulated chess piece character and the equipment A is calculated, and a score of matching of the simulated chess piece character b is the highest. In this case, it is known that it is most suitable to equip the simulated chess piece character b with the equipment A. Therefore, the simulated chess piece character b is first equipped with the equipment A. Later, after the simulated chess piece character a is obtained, the equipment A on the simulated chess piece character b is transferred to the simulated chess piece character a.

In the equipment configuration method for a simulated chess piece character provided in this embodiment, the computer device pre-allocates recommended equipment's to all the simulated chess piece characters in the lineup configuration based on the lineup configuration of the simulated chess piece characters, and equips the simulated chess piece character with the recommend equipment based on the pre-allocation result. In this application, recommended equipment's are pre-allocated at once based on the lineup configuration of the simulated chess piece characters in this game, and in the case that the simulated chess piece character meets the equipping condition, the simulated chess piece character is equipped with the recommended equipment. This avoids a process of calculating, each time a new piece of equipment is obtained, the matching between the new equipment and each simulated chess piece character, which reduces a computing amount and reduces the processing power consumption of the computer device. In the pre-allocation mechanism in this application, equipment's are not allocated completely based on the pre-allocation result. Even for the same lineup configuration and recommended equipment, different configuration results are generated because of different appearance orders of the recommended equipment's or the simulated chess piece characters in each game, thereby ensuring the diversity of equipment configurations.

In conclusion, in the equipment configuration method for a simulated chess piece character provided in this embodiment, the computer device displays a battle chessboard, the battle chessboard including at least one simulated chess piece character, and the simulated chess piece character being a chess piece character controlled by a robot account; in response to a lineup configuration of the simulated chess piece character in this game, displays recommended equipment corresponding to the simulated chess piece character; and in response to that the simulated chess piece character meets an equipping condition, displays the simulated chess piece character equipped with the recommended equipment. In this application, recommended equipment's corresponding to all simulated chess piece characters are obtained at once based on the lineup configuration of the simulated chess piece characters in this game, and in the case that the simulated chess piece character meets the equipping condition, the simulated chess piece character is equipped with the recommended equipment. This avoids a process of calculating, each time a new piece of equipment is obtained, the matching between the new equipment and each simulated chess piece character, which reduces a computing amount and reduces the processing power consumption of the computer device.

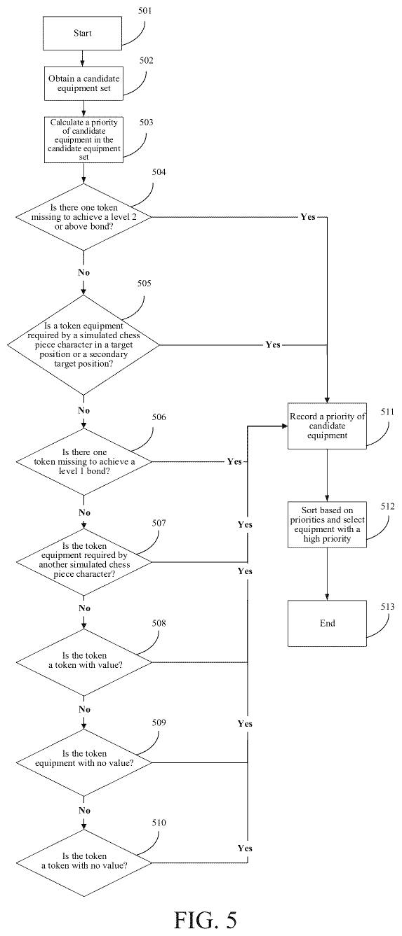

FIG. 5 is a flowchart of an equipment configuration method for a simulated chess piece character according to an exemplary embodiment of this application. This method may be performed by a computer device, and the computer device may be the terminal 100 or the server 200 in FIG. 2. This method includes:

Step 501: Start.

Step 502: Obtain a candidate equipment set.

The candidate equipment set refers to a set that may be used by a robot account to select equipment. The candidate equipment set includes equipment's corresponding to simulated chess piece characters in an entire game.

For example, the equipment includes occupation transfer tokens and regular equipment. The candidate equipment set includes occupation transfer tokens and regular equipment. Regular equipment is configured for increasing an attribute value of a simulated chess piece character, and provides attribute gains for the simulated chess piece character. The occupation transfer token is configured for changing a job attribute (referred to as “token” for short) of a simulated chess piece character. Both occupation transfer tokens and regular equipment may be used as equipment's to equip simulated chess piece characters.

In an embodiment, simulated chess piece characters may select occupation transfer tokens and/or regular equipment from the candidate equipment set for equipping.

Step 503: Calculate a priority of candidate equipment in the candidate equipment set.

For example, when the computer device selects equipment for a simulated chess piece character, the computer device traverses the candidate equipment's in the candidate equipment set, and calculates a priority of each candidate equipment for the simulated chess piece character.

Step 504: Is there one token missing to achieve a level 2 or above bond?

A bond means that when there are specific and related simulated chess piece characters on one side of the game, a degree of attribute enhancing is added to a corresponding simulated chess piece character. Bonds may be divided into different levels. Each level of bond corresponds to a number and a type of simulated chess piece characters, and a degree of attribute enhancing is added to this type of simulated chess piece characters.

For example, taking a “five tiger general” bond as an example, when there are two or more “five tiger general” simulated chess piece characters on any side of the game, the “five tiger general” bond is triggered. The bond effect is: increasing the attack power of each “five tiger general” simulated chess piece character.

The bond is used to enhance the strength of the lineup. The bond includes camp bond or work attribute bond. For example, when “a chess piece character Z” and “a chess piece character G” appear in the same team at the same time, the attack speed of the team increases by 40%.

For example, the candidate equipment is “token”, and when it is a case that a simulated chess piece character only lacks this “token” to be able to achieve a level 2 or above bond, operation 511 is performed. When it is not the case that a simulated chess piece character only lacks this “token” to be able to achieve a level 2 or above bond, operation 505 is performed.

Operation 505: Is the token equipment required by a simulated chess piece character in a target position or a secondary target position?

The target position is the center position on the battle chessboard, and is referred to as a position C.

The secondary target position is a position next to the center position on the battle chessboard, and is referred to as a secondary position C.

For example, when it is not the case that a simulated chess piece character only lacks this “token” to be able to achieve a level 2 or above bond, it is determined whether the “token” is equipment required by a simulated chess piece character in the target position or the secondary target position. When the “token” is the equipment required by the simulated chess piece character in the target position or the secondary target position, operation 511 is performed. When the “token” is not the equipment required by the simulated chess piece character in the target position or the secondary target position, operation 506 is performed.

Operation 506: Is there one token missing to achieve a level 1 bond?

The level 1 bond means that when there is a number and a type of simulated chess piece characters of level 1 on one side of the game, a level 1 attribute enhancing is added to this type of simulated chess piece characters. For example, when the “token” is not the equipment required by the simulated chess piece character in the target position or the secondary target position, it is determined whether it is a case that a simulated chess piece character only lacks this “token” to be able to achieve a level 1 bond. When it is the case that a simulated chess piece character only lacks this “token” to be able to achieve the level 1 bond, operation 511 is performed. When it is not the case that a simulated chess piece character only lacks this “token” to be able to achieve the level 1 bond, operation 507 is performed.

Operation 507: Is the token equipment required by another simulated chess piece character?

For example, when it is not the case that a simulated chess piece character only lacks this “token” to be able to achieve the level 1 bond, it is determined whether the “token” is equipment required by another simulated chess piece character, and when another simulated chess piece character requires the “token”, operation 511 is performed. When another simulated chess piece character does not require the “token”, operation 508 is performed.

Operation 508: Is the token a token with value?

For example, when another simulated chess piece character do not require the “token”, it is determined whether the “token” is a token with value. When the “token” is a token with value, operation 511 is performed. When the “token” is a token with no value, operation 509 is performed.

Operation 509: Is the token equipment with no value?

For example, when the “token” is a token with no value, it is determined whether the “token” is equipment with no value, and when the “token” is equipment with no value, operation 511 is performed. When the “token” is equipment with value, operation 510 is performed.

Operation 510: Is the token a token with no value?

For example, when the “token” is equipment with value, it is determined whether the “token” is a token with no value, and when the “token” is a token with no value, operation 511 is performed.

Operation 511: Record a priority of candidate equipment.

For example, the computer device records the priority of the candidate equipment.

Operation 512: Sort based on priorities and select equipment with a high priority.

For example, the computer device sorts according to priorities, and uses the equipment with a high priority as the recommended equipment of the simulated chess piece character.

### Operation 513: End.

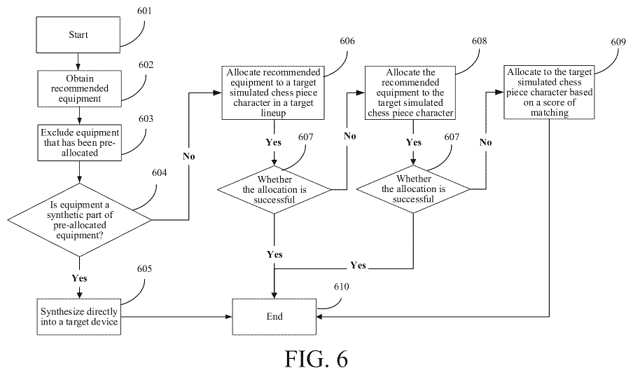

FIG. 6 is a flowchart of an equipment configuration method for a simulated chess piece character according to an exemplary embodiment of this application. This method may be performed by a computer device, and the computer device may be the terminal 100 or the server 200 in FIG. 2. This method includes:

Operation 601: Start.

Operation 602: Obtain recommended equipment.

For example, at the beginning of each turn, if new equipment is obtained or existing equipment of the simulated chess piece character is deleted, the computer device enters a pre-allocation process. The computer device obtains the selected recommended equipment.

Operation 603: Exclude equipment that has been pre-allocated.

For example, based on an existing pre-allocation result, the computer device excludes the allocated equipment from the recommended equipment's and allocates unallocated equipment.

Operation 604: Is equipment a synthetic part of pre-allocated equipment?

The synthetic part is a component that may be combined into a piece of equipment. In an embodiment, the synthetic part may be each component or part included in the equipment to be synthesized, or the synthetic part may be at least one piece of equipment, where an equipment level of the at least one piece of equipment is lower than an equipment level of the equipment to be synthesized.

For example, in the allocation process, there is a synthetic upgrade function between equipment's, that is, two small equipment's may be combined into one piece of large equipment. Therefore, it is determined whether the current equipment is a synthetic part of pre-allocated equipment. When the current equipment is a synthetic part of pre-allocated equipment, operation 605 is performed. When the current equipment is not a synthetic part of pre-allocated equipment, operation 606 is performed.

Operation 605: Synthesize directly into a target device.

When the current equipment is a synthetic part of pre-allocated equipment, the current equipment and the pre-allocated equipment are synthesized to obtain the target device.

Operation 606: Allocate the recommended equipment to a target simulated chess piece character in a target lineup of the equipment.

When the current equipment is not a synthetic part of the pre-allocated equipment, the computer device allocates the equipment to the target simulated chess piece character in the target lineup of the equipment, for example, allocates the equipment to a simulated chess piece character a in a first lineup.

Operation 607: Whether the allocation is successful.

It is determined whether the current equipment is allocated to the target simulated chess piece character. When the current equipment is allocated to the target simulated chess piece character in the target lineup, operation 610 is performed. When the current equipment is not allocated to the target simulated chess piece character in the target lineup, operation 608 is performed.

Operation 608: Allocate the recommended equipment to the target simulated chess piece character.

When the current equipment is not allocated to the target simulated chess piece character in the target lineup, the computer device allocates the current equipment to the target simulated chess piece character.

It is determined whether the current equipment is allocated to the target simulated chess piece character. When the current equipment is allocated to the target simulated chess piece character, operation 610 is performed. When the current equipment is not allocated to the target simulated chess piece character, operation 609 is performed.

Operation 609: Allocate to the target simulated chess piece character based on a score of allocating.

When the current equipment is not allocated to the target simulated chess piece character, the computer device calculates, based on a character attribute value and a recommended equipment attribute value, a score of matching between the recommended equipment and a simulated chess piece character, and the computer device allocates, based on scores of allocating, the recommended equipment to a simulated chess piece character with the highest score of allocating.

Operation 610: End.

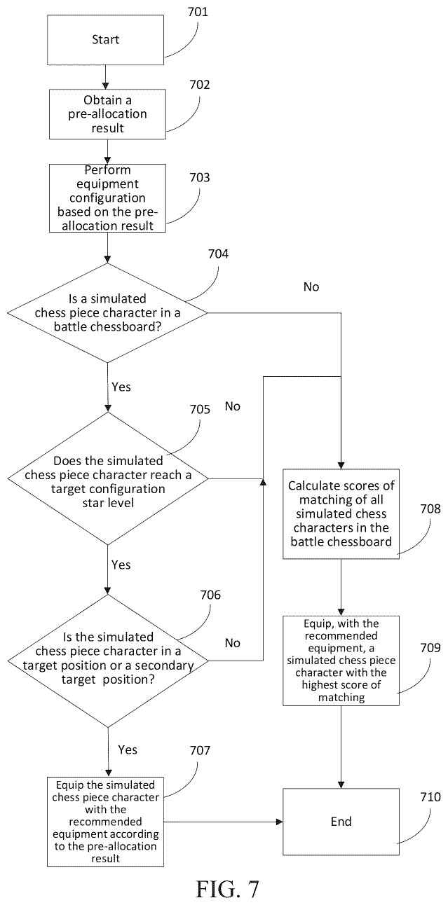

FIG. 7 is a flowchart of an equipment configuration method for a simulated chess piece character according to an exemplary embodiment of this application. This method may be performed by a computer device, and the computer device may be the terminal 100 or the server 200 in FIG. 2. This method includes:

Operation 701: Start.

Operation 702: Obtain a pre-allocation result.

For example, after pre-allocation of the obtained recommended equipment, the computer device obtains the pre-allocation result of the simulated chess piece character equipped with the recommended equipment.

Operation 703: Perform equipment configuration based on the pre-allocation result.

For example, the computer device equips each simulated chess piece character in the lineup configuration with recommended equipment based on the pre-allocation result.

Operation 704: Is the simulated chess piece character in a battle chessboard?

The computer device determines whether the simulated chess piece character in the lineup configuration is in the battle chessboard. When the simulated chess piece character is displayed in the battle chessboard, operation 705 is performed. When the simulated chess piece character is not displayed in the battle chessboard, operation 708 is performed.

Operation 705: Does the simulated chess piece character reach a target configuration star level?

The target configuration star level is configured for indicating a level of the simulated chess piece character.

When the simulated chess piece character is displayed in the battle chessboard, determining of the simulated chess piece character continues to be performed, to determine whether the simulated chess piece character reaches the target configuration star level. When the simulated chess piece character reaches the target configuration star level, operation 706 is performed. When the simulated chess piece character does not reach the target configuration star level, operation 708 is performed.

Operation 706: Is the simulated chess piece character in a target position or a secondary target position?

The target position is the center position on the battle chessboard, and is referred to as a position C.

The secondary target position is a position next to the center position on the battle chessboard, and is referred to as a secondary position C.

When the simulated chess piece character reaches the target configuration star level, determining of whether the simulated chess piece character is in the target position or the secondary target position continues to be performed, to determine whether the simulated chess piece character is in the target position or the secondary target position. When the simulated chess piece character is in the target position or the secondary target position, operation 707 is performed. When the simulated chess piece character is not in the target position or the secondary target position, operation 708 is performed.

Operation 707: Equip the simulated chess piece character with the recommended equipment according to the pre-allocation result.

When the simulated chess piece character is in the target position or the secondary target position, the computer device equips the simulated chess piece character with the recommended equipment based on the pre-allocation result.

Operation 708: Calculate scores of matching of all simulated chess characters on the battle chessboard.

For example, when the simulated chess piece character is not displayed on the battle chessboard, or the simulated chess piece character does not reach the target configuration star level, or the simulated chess piece character is not in the target position or the secondary target position, the computer device calculates, based on a character attribute value corresponding to a simulated chess piece character and a recommended equipment attribute value corresponding to recommended equipment, a score of matching between the recommended equipment and the simulated chess piece character.

Operation 709: Equip, with the recommended equipment, a simulated chess piece character with the highest score of matching.

For example, the computer device equips, with the recommended equipment, the simulated chess piece character with the highest score of matching.

Operation 710: End.

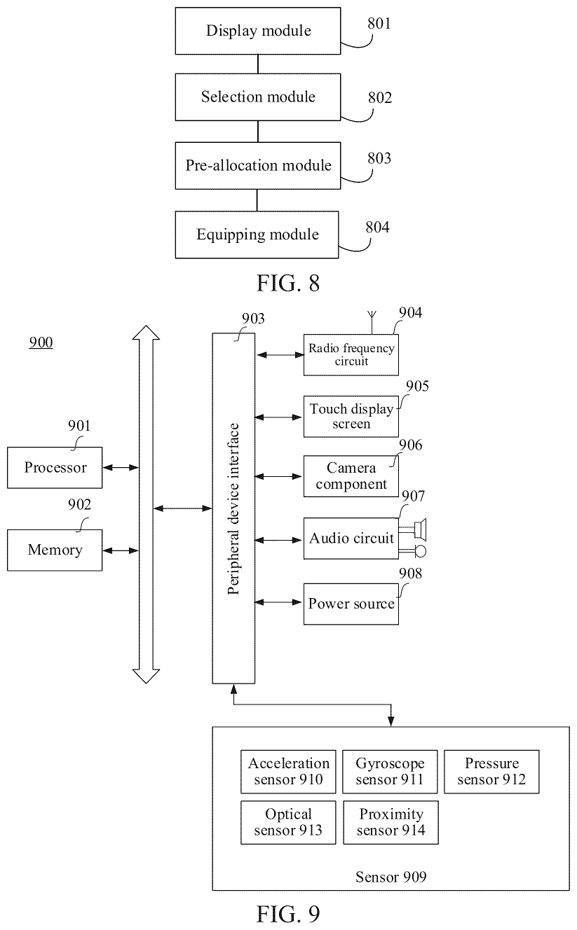

FIG. 8 is a block diagram of an equipment configuration apparatus for a simulated chess piece character according to an exemplary embodiment of this application. The apparatus may be implemented as all or part of a computer device through software, hardware, or a combination thereof. The apparatus includes: a display module 801, a selection module 802, a pre-allocation module 803, and an equipping module 804.

The display module 801 is configured to display a battle chessboard, the battle chessboard including at least one simulated chess piece character, the simulated chess piece character being a chess piece character controlled by a robot account, and the robot account being an account of a non-human player.

The display module 801 is configured to: in response to a lineup configuration of the simulated chess piece character in this game, display recommended equipment corresponding to the simulated chess piece character; the lineup configuration including at least one of the simulated chess piece character displayed on the battle chessboard and a simulated chess piece character that the robot account has not obtained yet, and the recommended equipment being recommended equipment obtained based on the simulated chess piece character in the lineup configuration.

The display module 801 is configured to: display, in response to that the simulated chess piece character meets an equipping condition, the simulated chess piece character equipped with the recommended equipment.

The selection module 802 is configured to obtain, based on character attribute information of the simulated chess piece character in the lineup configuration and candidate equipment attribute information of candidate equipment in a candidate equipment set, the recommended equipment corresponding to the simulated chess piece character; where
the lineup configuration refers to at least one of a name, a type, a number, and a character attribute configuration of the simulated chess piece character in this game, and the character attribute configuration includes the character attribute information.

In a possible implementation, the character attribute information includes a character attribute value, and the candidate equipment attribute information includes a candidate equipment attribute value; and the selection module 802 is configured to traverse candidate equipment's in the candidate equipment set, and when the candidate equipment is first selectable equipment of the simulated chess piece character, determine the candidate equipment as the recommended equipment corresponding to the simulated chess piece character; where the first selectable equipment is equipment whose score of matching with the simulated chess piece character in the current lineup configuration is greater than a first threshold.

In a possible implementation, the selection module 802 is configured to: when the candidate equipment is not the first selectable equipment of the simulated chess piece character, and instead is second selectable equipment of the simulated chess piece character, determine the candidate equipment as the recommended equipment corresponding to the simulated chess piece character; where the second selectable equipment is equipment whose score of matching with the simulated chess piece character in the current lineup configuration is greater than a second threshold.

In a possible implementation, the selection module 802 is configured to: when the candidate equipment is neither the first selectable equipment nor the second selectable equipment, calculate, based on the character attribute value and the candidate equipment attribute value, a score of matching between candidate equipment and the simulated chess piece character, and determine candidate equipment with the highest score of matching as the recommended equipment corresponding to the simulated chess piece character.

In a possible implementation, the character attribute information further includes equipment selection priority information of the simulated chess piece character; and the selection module 802 is configured to sequentially select equipment from the candidate equipment set for the simulated chess piece character based on the equipment selection priority information of the simulated chess piece character.

The pre-allocation module 803 is configured to pre-allocate the recommended equipment to the simulated chess piece character based on the lineup configuration of the simulated chess piece character, to obtain a pre-allocation result of the simulated chess piece character equipped with the recommended equipment.

In a possible implementation, the pre-allocation module 803 is configured to: equip, when the simulated chess piece character meets the equipping condition, the simulated chess piece character with the recommended equipment based on the pre-allocation result.

In a possible implementation, the pre-allocation module 803 is configured to traverse the simulated chess piece characters in the lineup configuration, and obtain, based on the character attribute information of the simulated chess piece character and the recommended equipment attribute information of the recommended equipment, the pre-allocation result of the simulated chess piece character equipped with the recommended equipment.

In a possible implementation, the character attribute information includes a character attribute value, and the recommended equipment attribute information includes a recommended attribute value; and the pre-allocation module 803 is configured to: when the recommended equipment is the first selectable equipment of the simulated chess piece character, allocate the recommended equipment to the simulated chess piece character.

In a possible implementation, the pre-allocation module 803 is configured to: when the recommended equipment is not the first selectable equipment of the simulated chess piece character, and instead is the second selectable equipment of the simulated chess piece character, allocate the recommended equipment to the simulated chess piece character.

In a possible implementation, the pre-allocation module 803 is configured to: when the recommended equipment is neither the first selectable equipment nor the second selectable equipment, calculate, based on the character attribute value and the recommended equipment attribute value, a score of allocating the recommended equipment to the simulated chess piece character, and allocate the recommended equipment to the simulated chess piece character with the highest score of allocating.

The equipping module 804 is configured to: when the simulated chess piece character is displayed on the battle chessboard, equip the corresponding simulated chess piece character with the recommended equipment based on the pre-allocation result.

In a possible implementation, the equipping module 804 is configured to: when the simulated chess piece character is not displayed on the battle chessboard, calculate, based on the character attribute value corresponding to the simulated chess piece character and the recommended equipment attribute value corresponding to the recommended equipment, a score of matching between the simulated chess piece character and the recommended equipment, and equip, with the recommended equipment, the simulated chess piece character with the highest score of matching.

For specific limitations in the one or more embodiments of the equipment configuration apparatus for a simulated chess piece character provided above, refer to limitations on the equipment configuration method for a simulated chess piece character provided above. Details are not described again herein. The modules of the above apparatus may be implemented in whole or in part by software, hardware, and a combination thereof. The modules may be embedded in a processor in a computer device in the form of hardware or independent of the processor in the computer device, and may also be stored in a memory of the computer device in the form of software, so that the processor may invoke and perform corresponding operations of the modules.

FIG. 9 is a structural block diagram of a computer device 900 according to an exemplary embodiment of this application. The computer device 900 may be a portable mobile terminal, for example, a smartphone, a tablet computer, a moving picture experts group audio layer III (MP3) player, or a moving picture experts group audio layer IV (MP4) player. The computer device 900 may also be referred to as a user device, a portable terminal, or other names.

Generally, the computer device 900 includes: a processor 901 and a memory 902.

The processor 901 may include one or more processing cores, for example, a 4-core processor or an 8-core processor. The processor 901 may be implemented in at least one hardware form of a digital signal processor (DSP), a field-programmable gate array (FPGA), and a programmable logic array (PLA). The processor 901 may also include a main processor and a co-processor. The main processor is a processor configured to process data in an awake state, and is also referred to as a central processing unit (CPU). The co-processor is a low power consumption processor configured to process data in a standby state. In some embodiments, the processor 901 may be integrated with a graphics processing unit (GPU). The GPU is configured to render and draw content that needs to be displayed on a display screen. In some embodiments, the processor 901 may further include an artificial intelligence (AI) processor. The AI processor is configured to process computing operations related to machine learning.

The memory 902 may include one or more computer-readable storage mediums. The computer-readable storage medium may be visible and non-transient. The memory 902 may further include a high-speed random access memory and a nonvolatile memory, for example, one or more magnetic disk storage devices or flash storage devices. In some embodiments, the non-transitory computer-readable storage medium in the memory 902 is configured to store at least one instruction. The at least one instruction is configured to be executed by the processor 901 to implement the equipment configuration method for a simulated chess piece character provided in the embodiments of this application.

In some embodiments, the computer device 900 further includes: a peripheral device interface 903 and at least one peripheral device. Specifically, the peripheral device includes: at least one of a radio frequency (RF) circuit 904, a touch display screen 905, a camera component 906, an audio circuit 907, and a power supply 908.

The peripheral device interface 903 may be configured to connect the at least one peripheral device related to input/output (I/O) to the processor 901 and the memory 902. In some embodiments, the processor 901, the memory 902, and the peripheral device interface 903 are integrated on the same chip or circuit board. In some other embodiments, any one or two of the processor 901, the memory 902 and the peripheral device interface 903 may be implemented on a single chip or circuit board. This is not limited in this embodiment.

The radio frequency circuit 904 is configured to receive and transmit an RF signal, also referred to as an electromagnetic signal. The radio frequency circuit 904 communicates with a communication network and other communication devices through the electromagnetic signal. The radio frequency circuit 904 converts an electric signal into an electromagnetic signal for transmission, or converts a received electromagnetic signal into an electric signal. In an embodiment, the radio frequency circuit 904 includes: an antenna system, an RF transceiver, one or more amplifiers, a tuner, an oscillator, a digital signal processor, a codec chip set, a subscriber identity module card, and the like. The radio frequency circuit 904 may communicate with another terminal by using at least one wireless communications protocol. The wireless communications protocol includes but is not limited to: a worldwide web, a metropolitan area network, an intranet, various generations of mobile communication networks (2G, 3G, 4G, and 5G), a wireless local area network, and/or a wireless fidelity (Wi-Fi) network. In some embodiments, the radio frequency circuit 904 may further include a circuit related to near field communication (NFC). This is not limited in this application.

The touch display screen 905 is configured to display a user interface (UI). The UI may include a graph, a text, an icon, a video, and any combination thereof. The touch display screen 905 further has a capability of acquiring a touch signal on or above a surface of the touch display screen 905. The touch signal may be inputted to the processor 901 as a control signal for processing. The touch display screen 905 is configured to provide a virtual button and/or a virtual keyboard that are/is also referred to as a soft button and/or a soft keyboard. In some embodiments, there may be one touch display screen 905, which is disposed on the front panel of the computer device 900. In some other embodiments, there may be at least two touch display screens 905, which are respectively disposed on different surfaces of the computer device 900 or have a folding design. In some embodiments, the touch display screen 905 may be a flexible display screen disposed on a curved or folded surface of the computer device 900. Even, the touch display screen 905 may be further disposed in a non-rectangular irregular pattern, that is, a special-shaped screen. The touch display screen 905 may be prepared by using materials such as a liquid crystal display (LCD), an organic light-emitting diode (OLED), or the like.

The camera component 906 is configured to capture images or videos. In an embodiment, the camera component 906 includes a front-facing camera and a rear-facing camera. Generally, the front-facing camera is configured to implement video calls or selfies, and the rear-facing camera is configured to capture photos or videos. In some embodiments, there are at least two rear-facing cameras, which are respectively any of a main camera, a depth-of-field camera, and a wide-angle camera, to achieve background blur through fusion of the main camera and the depth-of-field camera, and panoramic photographing and virtual reality (VR) photographing through fusion of the main camera and the wide-angle camera. In some embodiments, the camera component 906 may further include a flash. The flash may be a monochrome temperature flash, or may be a double color temperature flash. The double color temperature flash refers to a combination of a warm light flash and a cold light flash, and may be used for light compensation under different color temperatures.

The audio circuit 907 is configured to provide an audio interface between the user and the computer device 900. The audio circuit 907 may include a microphone and a speaker. The microphone is configured to acquire sound waves of a user and an environment, and convert the sound waves into an electrical signal to input to the processor 901 for processing, or input to the radio frequency circuit 904 for implementing voice communication. For the purpose of stereo acquisition or noise reduction, there may be a plurality of microphones, respectively disposed at different portions of the computer device 900. The microphone may further be an array microphone or an omni-directional acquisition type microphone. The speaker is configured to convert electric signals from the processor 901 or the radio frequency circuit 904 into sound waves. The speaker may be a conventional film speaker, or may be a piezoelectric ceramic speaker. When the speaker is the piezoelectric ceramic speaker, the speaker not only may convert an electric signal into sound waves audible to human beings, but also may convert an electric signal into sound waves inaudible to human beings, for ranging and other purposes. In some embodiments, the audio circuit 907 may further include an earphone jack.

The power supply 908 is configured to supply power to components in the computer device 900. The power supply 908 may be an alternating current battery, a direct current battery, a primary battery, or a rechargeable battery. When the power supply 908 includes a rechargeable battery, the rechargeable battery may be a wired rechargeable battery or a wireless rechargeable battery. The wired rechargeable battery is a battery charged through a wired circuit, and the wireless rechargeable battery is a battery charged through a wireless coil. The rechargeable battery may be further configured to support a fast charging technology.

In some embodiments, the computer device 900 further includes one or more sensors 909. The one or more sensors 909 include, but are not limited to: an acceleration sensor 910, a gyroscope sensor 911, a pressure sensor 912, an optical sensor 913, and a proximity sensor 914.

The acceleration sensor 910 may detect a magnitude of acceleration on three coordinate axes of a coordinate system established with the computer device 900. For example, the acceleration sensor 910 may be configured to detect components of gravity acceleration on the three coordinate axes. The processor 901 may control, according to a gravity acceleration signal acquired by the acceleration sensor 910, the touch display screen 905 to display the user interface in a landscape view or a portrait view. The acceleration sensor 910 may be further configured to acquire motion data of a game or a user.

The gyroscope sensor 911 may detect a body direction and a rotation angle of the computer device 900. The gyroscope sensor 911 may cooperate with the acceleration sensor 910 to acquire a 3D action by the user on the computer device 900. The processor 901 may implement the following functions according to the data acquired by the gyroscope sensor 911: motion sensing (such as changing the UI according to a tilt operation of the user), image stabilization at shooting, game control, and inertial navigation.

The pressure sensor 912 may be disposed at a side frame of the computer device 900 and/or a lower layer of the touch display screen 905. When the pressure sensor 912 is disposed at the side frame of the computer device 900, a holding signal of the user on the computer device 900 may be detected. Left and right hand recognition or a quick operation is performed according to the holding signal. When the pressure sensor 912 is disposed on the lower layer of the touch display screen 905, an operable control on the UI interface may be controlled according to a pressure operation of the user on the touch display screen 905. The operable control includes at least one of a button control, a scroll-bar control, an icon control, and a menu control.

The optical sensor 913 is configured to acquire ambient light intensity. In an embodiment, the processor 901 may control the display brightness of the touch display screen 905 according to the ambient light intensity acquired by the optical sensor 913. Specifically, when the ambient light intensity is relatively high, the display brightness of the touch display screen 905 is increased. When the ambient light intensity is relatively low, the display brightness of the touch display screen 905 is decreased. In another embodiment, the processor 901 may further dynamically adjust a camera parameter of the camera component 906 according to the ambient light intensity acquired by the optical sensor 913.

The proximity sensor 914, also referred to as a distance sensor, is generally disposed on the front panel of the computer device 900. The proximity sensor 914 is configured to acquire a distance between the user and the front panel of the computer device 900. In an embodiment, when the proximity sensor 914 detects that the distance between the user and the front panel of the computer device 900 gradually decreases, the touch display screen 905 is controlled by the processor 901 to switch from the screen-on state to the screen-off state. When the proximity sensor 914 detects that the distance between the user and the front panel of the computer device 900 gradually increases, the touch display screen 905 is controlled by the processor 901 to switch from the screen-off state to the screen-on state.

A person skilled in the art may understand that the structure shown in FIG. 9 constitutes no limitation on the computer device 900, and the computer device may include more or fewer components than those shown in the figure, or some components may be combined, or a different component deployment may be used.

An embodiment of this application further provides a computer device, including a processor and a memory, the memory storing at least one computer program, and the at least one computer program being loaded and executed by the processor to implement the equipment configuration method for a simulated chess piece character according to the foregoing method embodiments.

An embodiment of this application further provides a non-transitory computer-readable storage medium, storing at least one computer program, and the at least one computer program being loaded and executed by a processor to implement the equipment configuration method for a simulated chess piece character according to the foregoing method embodiments.

An embodiment of this application further provides a computer program product, including a computer program, the computer program being stored in a computer-readable storage medium. The computer program is read and executed by a processor of a computer device from the computer-readable storage medium, so that the computer device implements the equipment configuration method for a simulated chess piece character according to the foregoing method embodiments.

In a specific implementation of this application, for related data in user data processing related to user identities or characteristics such as data involved, historical data, and portraits, when the embodiments of this application are applied to a specific product or technology, it is necessary to obtain the user's permission or consent, and the collection, usage, and processing of related data need to comply with relevant laws, regulations and standards of relevant countries and regions.

“Plurality of” mentioned in the specification means two or more. “And/or” describes an association relationship between associated objects, and represents that there may be three relationships. For example, A and/or B may represent three cases: Only A exists, both A and B exist, and only B exists. The character “/” in this specification generally indicates an “or” relationship between the associated objects.

A person of ordinary skill in the art may understand that all or some of the operations of the foregoing embodiments may be implemented by hardware, or may be implemented by a program instructing relevant hardware. The program may be stored in a computer-readable storage medium. The storage medium may be a read-only memory, a magnetic disk, an optical disc, or the like.

The foregoing descriptions are merely embodiments of this application, but are not intended to limit this application. Any modification, equivalent replacement, or improvement made within the spirit and principle of this application shall fall within the protection scope of this application.

What is claimed is:

1. A method for configuring equipment for a simulated chess piece character performed by a computer device, the method comprising:
displaying a battle chessboard, the battle chessboard comprising at least one simulated chess piece character controlled by a robot account;
in response to a lineup configuration of the simulated chess piece character in this game, displaying recommended equipment corresponding to the simulated chess piece character, the lineup configuration comprising at least one of the simulated chess piece character displayed on the battle chessboard and a simulated chess piece character that the robot account has not obtained yet; and
in response to that the simulated chess piece character meets an equipping condition, assigning the recommended equipment to the robot account and displaying the simulated chess piece character equipped with the recommended equipment.

2. The method according to claim 1, wherein the assigning the recommended equipment to the robot account and displaying the simulated chess piece character equipped with the recommended equipment comprises:
obtaining, based on character attribute information of the simulated chess piece character in the lineup configuration and candidate equipment attribute information of candidate equipment in a candidate equipment set, the recommended equipment corresponding to the simulated chess piece character; wherein
the lineup configuration refers to at least one of a name, a type, a number, and a character attribute configuration of the simulated chess piece character in this game, and the character attribute configuration comprises the character attribute information.

3. The method according to claim 2, wherein the character attribute information comprises a character attribute value, and the candidate equipment attribute information comprises a candidate equipment attribute value; and
the obtaining, based on character attribute information of the simulated chess piece character in the lineup configuration and candidate equipment attribute information of candidate equipment in a candidate equipment set, the recommended equipment corresponding to the simulated chess piece character comprises:
traversing candidate equipment's in the candidate equipment set, and when the candidate equipment is first selectable equipment of the simulated chess piece character, determining the candidate equipment as the recommended equipment corresponding to the simulated chess piece character; wherein the first selectable equipment is equipment whose score of matching with the simulated chess piece character in the current lineup configuration is greater than a first threshold;
when the candidate equipment is not the first selectable equipment of the simulated chess piece character, and instead is second selectable equipment of the simulated chess piece character, determining the candidate equipment as the recommended equipment corresponding to the simulated chess piece character; the second selectable equipment is equipment whose score of matching with the simulated chess piece character in the current lineup configuration is greater than a second threshold; and
when the candidate equipment is neither the first selectable equipment nor the second selectable equipment, calculating, based on the character attribute value and the candidate equipment attribute value, a score of matching between candidate equipment and the simulated chess piece character, and determining candidate equipment with the highest score of matching as the recommended equipment corresponding to the simulated chess piece character.

4. The method according to claim 3, wherein the character attribute information further comprises equipment selection priority information of the simulated chess piece character; and the method further comprises:
sequentially selecting equipment from the candidate equipment set for the simulated chess piece character based on the equipment selection priority information of the simulated chess piece character.

5. The method according to claim 1, wherein the assigning the recommended equipment to the robot account and displaying the simulated chess piece character equipped with the recommended equipment comprises:
pre-allocating the recommended equipment to the simulated chess piece character based on the lineup configuration of the simulated chess piece character, to obtain a pre-allocation result of the simulated chess piece character equipped with the recommended equipment; and
equipping, when the simulated chess piece character meets the equipping condition, the simulated chess piece character with the recommended equipment based on the pre-allocation result.

6. The method according to claim 5, wherein the pre-allocating the recommended equipment to the simulated chess piece character based on the lineup configuration of the simulated chess piece character, to obtain a pre-allocation result of the simulated chess piece character equipped with the recommended equipment comprises:
traversing the simulated chess piece characters in the lineup configuration, and obtaining, based on the character attribute information of the simulated chess piece character and the recommended equipment attribute information of the recommended equipment, the pre-allocation result of the simulated chess piece character equipped with the recommended equipment.

7. The method according to claim 6, wherein the character attribute information comprises a character attribute value, and the recommended equipment attribute information comprises a recommended attribute value; and
the obtaining, based on the character attribute information of the simulated chess piece character and the recommended equipment attribute information of the recommended equipment, the pre-allocation result of the simulated chess piece character equipped with the recommended equipment comprises:
when the recommended equipment is the first selectable equipment of the simulated chess piece character, allocating the recommended equipment to the simulated chess piece character;
when the recommended equipment is not the first selectable equipment of the simulated chess piece character, and instead is the second selectable equipment of the simulated chess piece character, allocating the recommended equipment to the simulated chess piece character; and
when the recommended equipment is neither the first selectable equipment nor the second selectable equipment, calculating, based on the character attribute value and the recommended equipment attribute value, a score of allocating the recommended equipment to the simulated chess piece character, and allocating the recommended equipment to the simulated chess piece character with the highest score of allocating.

8. The method according to claim 5, wherein the equipping, when the simulated chess piece character meets the equipping condition, the simulated chess piece character with the recommended equipment based on the pre-allocation result comprises:
when the simulated chess piece character is displayed on the battle chessboard, equipping the corresponding simulated chess piece character with the recommended equipment based on the pre-allocation result; and
when the simulated chess piece character is not displayed on the battle chessboard, calculating, based on the character attribute value corresponding to the simulated chess piece character and the recommended equipment attribute value corresponding to the recommended equipment, a score of matching between the simulated chess piece character and the recommended equipment, and equipping, with the recommended equipment, the simulated chess piece character with the highest score of matching.

9. A computer device, comprising: a processor and a memory, the memory storing at least one computer program, and the at least one computer program, when loaded and executed by the processor, causing the computer device to implement a method for configuring equipment for a simulated chess piece character including:
displaying a battle chessboard, the battle chessboard comprising at least one simulated chess piece character controlled by a robot account;
in response to a lineup configuration of the simulated chess piece character in this game, displaying recommended equipment corresponding to the simulated chess piece character, the lineup configuration comprising at least one of the simulated chess piece character displayed on the battle chessboard and a simulated chess piece character that the robot account has not obtained yet; and
in response to that the simulated chess piece character meets an equipping condition, assigning the recommended equipment to the robot account and displaying the simulated chess piece character equipped with the recommended equipment.

10. The computer device according to claim 9, wherein the assigning the recommended equipment to the robot account and displaying the simulated chess piece character equipped with the recommended equipment comprises:
obtaining, based on character attribute information of the simulated chess piece character in the lineup configuration and candidate equipment attribute information of candidate equipment in a candidate equipment set, the recommended equipment corresponding to the simulated chess piece character; wherein
the lineup configuration refers to at least one of a name, a type, a number, and a character attribute configuration of the simulated chess piece character in this game, and the character attribute configuration comprises the character attribute information.

11. The computer device according to claim 10, wherein the character attribute information comprises a character attribute value, and the candidate equipment attribute information comprises a candidate equipment attribute value; and
the obtaining, based on character attribute information of the simulated chess piece character in the lineup configuration and candidate equipment attribute information of candidate equipment in a candidate equipment set, the recommended equipment corresponding to the simulated chess piece character comprises:
traversing candidate equipment's in the candidate equipment set, and when the candidate equipment is first selectable equipment of the simulated chess piece character, determining the candidate equipment as the recommended equipment corresponding to the simulated chess piece character; wherein the first selectable equipment is equipment whose score of matching with the simulated chess piece character in the current lineup configuration is greater than a first threshold;
when the candidate equipment is not the first selectable equipment of the simulated chess piece character, and instead is second selectable equipment of the simulated chess piece character, determining the candidate equipment as the recommended equipment corresponding to the simulated chess piece character; the second selectable equipment is equipment whose score of matching with the simulated chess piece character in the current lineup configuration is greater than a second threshold; and
when the candidate equipment is neither the first selectable equipment nor the second selectable equipment, calculating, based on the character attribute value and the candidate equipment attribute value, a score of matching between candidate equipment and the simulated chess piece character, and determining candidate equipment with the highest score of matching as the recommended equipment corresponding to the simulated chess piece character.

12. The computer device according to claim 11, wherein the character attribute information further comprises equipment selection priority information of the simulated chess piece character; and the method further comprises:
sequentially selecting equipment from the candidate equipment set for the simulated chess piece character based on the equipment selection priority information of the simulated chess piece character.

13. The computer device according to claim 9, wherein the assigning the recommended equipment to the robot account and displaying the simulated chess piece character equipped with the recommended equipment comprises:
pre-allocating the recommended equipment to the simulated chess piece character based on the lineup configuration of the simulated chess piece character, to obtain a pre-allocation result of the simulated chess piece character equipped with the recommended equipment; and
equipping, when the simulated chess piece character meets the equipping condition, the simulated chess piece character with the recommended equipment based on the pre-allocation result.

14. The computer device according to claim 13, wherein the pre-allocating the recommended equipment to the simulated chess piece character based on the lineup configuration of the simulated chess piece character, to obtain a pre-allocation result of the simulated chess piece character equipped with the recommended equipment comprises:
traversing the simulated chess piece characters in the lineup configuration, and obtaining, based on the character attribute information of the simulated chess piece character and the recommended equipment attribute information of the recommended equipment, the pre-allocation result of the simulated chess piece character equipped with the recommended equipment.

15. The computer device according to claim 14, wherein the character attribute information comprises a character attribute value, and the recommended equipment attribute information comprises a recommended attribute value; and
the obtaining, based on the character attribute information of the simulated chess piece character and the recommended equipment attribute information of the recommended equipment, the pre-allocation result of the simulated chess piece character equipped with the recommended equipment comprises:
when the recommended equipment is the first selectable equipment of the simulated chess piece character, allocating the recommended equipment to the simulated chess piece character;
when the recommended equipment is not the first selectable equipment of the simulated chess piece character, and instead is the second selectable equipment of the simulated chess piece character, allocating the recommended equipment to the simulated chess piece character; and
when the recommended equipment is neither the first selectable equipment nor the second selectable equipment, calculating, based on the character attribute value and the recommended equipment attribute value, a score of allocating the recommended equipment to the simulated chess piece character, and allocating the recommended equipment to the simulated chess piece character with the highest score of allocating.

16. The computer device according to claim 13, wherein the equipping, when the simulated chess piece character meets the equipping condition, the simulated chess piece character with the recommended equipment based on the pre-allocation result comprises:
when the simulated chess piece character is displayed on the battle chessboard, equipping the corresponding simulated chess piece character with the recommended equipment based on the pre-allocation result; and
when the simulated chess piece character is not displayed on the battle chessboard, calculating, based on the character attribute value corresponding to the simulated chess piece character and the recommended equipment attribute value corresponding to the recommended equipment, a score of matching between the simulated chess piece character and the recommended equipment, and equipping, with the recommended equipment, the simulated chess piece character with the highest score of matching.

17. A non-transitory computer-readable storage medium, storing at least one computer program, and the at least one computer program, when loaded and executed by a processor of a computer device, causing the computer device to perform a method for configuring equipment for a simulated chess piece character including:
displaying a battle chessboard, the battle chessboard comprising at least one simulated chess piece character controlled by a robot account;
in response to a lineup configuration of the simulated chess piece character in this game, displaying recommended equipment corresponding to the simulated chess piece character, the lineup configuration comprising at least one of the simulated chess piece character displayed on the battle chessboard and a simulated chess piece character that the robot account has not obtained yet; and
in response to that the simulated chess piece character meets an equipping condition, assigning the recommended equipment to the robot account and displaying the simulated chess piece character equipped with the recommended equipment.

18. The non-transitory computer-readable storage medium according to claim 17, wherein the assigning the recommended equipment to the robot account and displaying the simulated chess piece character equipped with the recommended equipment comprises:
obtaining, based on character attribute information of the simulated chess piece character in the lineup configuration and candidate equipment attribute information of candidate equipment in a candidate equipment set, the recommended equipment corresponding to the simulated chess piece character; wherein
the lineup configuration refers to at least one of a name, a type, a number, and a character attribute configuration of the simulated chess piece character in this game, and the character attribute configuration comprises the character attribute information.

19. The non-transitory computer-readable storage medium according to claim 17, wherein the assigning the recommended equipment to the robot account and displaying the simulated chess piece character equipped with the recommended equipment comprises:
pre-allocating the recommended equipment to the simulated chess piece character based on the lineup configuration of the simulated chess piece character, to obtain a pre-allocation result of the simulated chess piece character equipped with the recommended equipment; and
equipping, when the simulated chess piece character meets the equipping condition, the simulated chess piece character with the recommended equipment based on the pre-allocation result.

20. The non-transitory computer-readable storage medium according to claim 19, wherein the pre-allocating the recommended equipment to the simulated chess piece character based on the lineup configuration of the simulated chess piece character, to obtain a pre-allocation result of the simulated chess piece character equipped with the recommended equipment comprises:
traversing the simulated chess piece characters in the lineup configuration, and obtaining, based on the character attribute information of the simulated chess piece character and the recommended equipment attribute information of the recommended equipment, the pre-allocation result of the simulated chess piece character equipped with the recommended equipment.
